(19) United States
(12) Patent Application Publication
(10) Pub. No.: US 2008/0153561 A1
(43) Pub. Date: Jun. 26, 2008

(54) GAMING MACHINE, GAMING MACHINE CONTROL METHOD, AND PLAYING METHOD

(75) Inventor: Hirobumi TOYODA, Tokyo (JP)

Correspondence Address: ARENT FOX LLP, 1050 CONNECTICUT AVENUE, N.W., SUITE 400, WASHINGTON, DC, 20036, US

(73) Assignee: Aruze Corp., Tokyo (JP)

(21) Appl. No.: 11/961,746

(22) Filed: Dec. 20, 2007

(30) Foreign Application Priority Data
Dec. 22, 2006 (JP) 2006345482

(51) Int. Cl. A63F 13/00

(52) U.S. Cl. 463/13

(57) ABSTRACT

A gaming machine is provided, which includes a display and a controller. The controller controls the display so as to display an image related to a high-probability win game. The controller is configured with logic to: (a) distribute cards to a player; (b) exchange one or more of the distributed cards selected by the player with different cards; (c) execute a win game in which the player wins a predetermined award when the final cards possessed by the player includes a first predetermined card combination; (d) execute a plurality of high-probability win games in a subsequent game when the final cards include a second predetermined card combination; and (e) execute a special game so as to determine an allowable number of times to exchange cards prior to executing a high-probability win game.

This application is based on and claims the benefit of priority from Japanese Patent Application No. 2006-345482, filed on 22 Dec. 2006, the content of which is incorporated herein by reference.

### BACKGROUND OF THE INVENTION

1. Field of the Invention

The present invention relates to a gaming machine, a method of controlling a gaming machine and a method of playing a game.

2. Related Art

Conventionally, gaming machines such as poker gaming machines installed in casinos execute a win game where a player wins when a plurality of cards finally distributed to the player includes a predetermined combination. In this type of gaming machine, for each poker game, medals are supplied in accordance with the achieved poker hand and the award determined by the number of inserted medals.

Recently, a gaming machine has been supplied which performs a high-probability win game, thereby increasing the probability of winning. As a gaming machine of this type, for example, U.S. Pat. No. 5,882,260 provides a gaming machine where two sets of five cards instead of a set thereof are distributed to each player, and the cards of the two sets are combined to achieve a poker hand.

For the purposes of increasing the number of medals supplied to each poker game, a new gaming style called a double-down game is being added recently, which is able to double the medal payout number after a poker hand is achieved.

### SUMMARY OF THE INVENTION

The present invention aims at providing a gaming machine having a new gaming style enhancing expectations for medals, as well as a gaming machine control method and a playing method.

In an aspect of the present invention, a gaming machine is provided, which includes a display and a controller. The controller controls the display so as to display an image related to a high-probability win game. The controller is configured with logic to: (a) distribute cards to a player; (b) exchange one or more of the distributed cards selected by the player with different cards; (c) execute a win game in which the player wins a predetermined award when the final cards possessed by the player includes a first predetermined card combination; (d) execute a plurality of high-probability win games in a subsequent game when the final cards include a second predetermined card combination; and (e) execute a special game so as to determine an allowable number of times to exchange cards prior to executing a high-probability win game.

In another aspect of the present invention, a gaming machine is provided, in which the allowable number of times to exchange cards is a total number allowed for the plurality of high-probability win games continuously performed. The controller is further configured with logic to: (f) control the allowable number of times to exchange cards to be consumed in the plurality of high-probability win games.

In still another aspect of the present invention, a gaming machine is provided, in which the controller performs a special game for each high-probability win game.

In yet another aspect of the present invention, a gaming machine is provided, which includes a display and a controller. The controller controls the display so as to display an image related to a high-probability win game. The controller is configured with logic to: (a) distribute cards to a player; (b) exchange one or more of the distributed cards selected by the player with different cards; (c) execute a win game in which the player wins a predetermined award when the final cards possessed by the player includes a first predetermined card combination; (d) execute a plurality of high-probability win games in a subsequent game when the final cards include a second predetermined card combination; (e) execute a special game so as to determine an allowable total number of times to exchange cards for the plurality of high-probability of win games prior to executing a high-probability win game; and (f) control the allowable number of times to exchange cards to be consumed in the plurality of high-probability win games.

In a further aspect of the present invention, a gaming machine is provided, which includes a display and a controller. The controller controls the display so as to display an image related to a high-probability win game. The controller is configured with logic to: (a) distribute cards to a player; (b) exchange one or more of the distributed cards selected by the player with different cards; (c) execute a win game in which the player wins a predetermined award when the final cards possessed by the player includes a first predetermined card combination; (d) execute a plurality of high-probability win games in a subsequent game when the final cards include a second predetermined card combination; and (e) execute a special game so as to determine an allowable number of times to exchange cards prior to executing a high-probability win game. The controller is configured with logic to execute a special game for each high-probability win game.

In a still further aspect of the present invention, a method of controlling a gaming machine with a display is provided. The method includes the steps of: (a) distributing cards to a player; (b) exchanging one or more of the distributed cards selected by the player with different cards; (c) executing a win game in which the player wins a predetermined award when the final cards possessed by the player includes a first predetermined card combination; (d) executing a plurality of high-probability win games in a subsequent game when the final cards include a second predetermined card combination; (e) executing a special game so as to determine an allowable number of times to exchange cards prior to executing a high-probability win game; and (f) controlling the display so as to display an image related to the high-probability win game.

In a yet further aspect of the present invention, a method is provided, in which the allowable number of times to exchange cards is a total number allowed for the plurality of high-probability win games continuously performed. The method further includes the step of: (g) controlling the allowable number of times to exchange cards to be consumed in the plurality of high-probability win games.

In an aspect of the present invention, a method is provided, in which the controller performs a special game for each high-probability win game.

In another aspect of the present invention, a method of playing a win game is provided. The method includes the steps of: (a) distributing cards to a player; (b) exchanging one or more of the distributed cards selected by the player with different cards; (c) executing a win game in which the player wins a predetermined award when the final cards possessed by the player include a first predetermined card combination; (d) executing a plurality of high-probability win games in a subsequent game when the final cards include a second predetermined card combination; and (e) executing a special game so as to determine an allowable number of times to exchange cards prior to executing a high-probability win game.

Thus, the present invention is able to provide a gaming machine having a new gaming style enhancing expectations for medals, as well as a gaming machine control method and a playing method.

Additional features and advantages of the present invention are described in, and are apparent from, the following detailed description of the invention and the drawings.

### BRIEF DESCRIPTION OF THE DRAWINGS

FIG. 1 is a flow chart illustrating the flow of a game according to a first embodiment of the invention;

FIG. 2 is a schematic diagram illustrating the overall view of a poker machine according to the first embodiment;

FIG. 3 is a block diagram illustrating the electrical configuration of the poker machine in the first embodiment;

FIGS. 4 to 11 are flow charts illustrating the flow of processing of the poker machine in the first embodiment;

FIGS. 12 to 22 are schematic diagrams illustrating display screens to be displayed on the poker machine in the first embodiment; and

FIGS. 23 and 24 are flow charts illustrating the flow of processing of a poker machine according to a second embodiment of the invention.

### DETAILED DESCRIPTION OF THE INVENTION

### First Embodiment

a. Outline of Playing Method

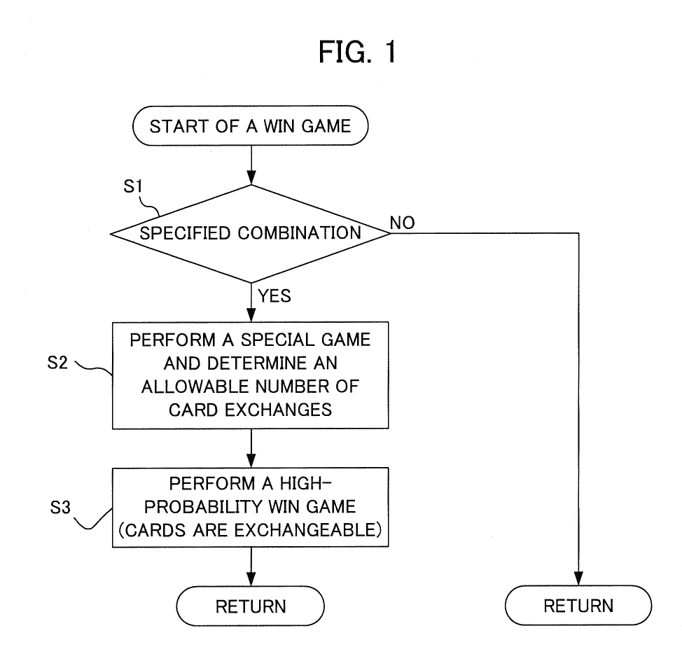

FIG. 1 is a flow chart illustrating a method of playing a game according to a first embodiment of the invention. The method of playing a game according to the present embodiment relates to a kind of poker game that performs a win game. The win game uses a plurality of kinds of cards and allows a player to exchange a card selected by the player from a plurality of cards distributed initially with another card. When the player wins the game with a plurality of cards finally distributed that matches a predetermined combination, the player receives a predetermined award. In the above win game, the playing method first judges if a specified combination is achieved (step S1). When the specified combination occurs in step S1, for example, Straight Flush, etc., a special game (for example, a card game of gathering pairs of cards bearing the same number or face) is performed to determine an allowable number of card exchanges (step S2). Then, a high-probability win game is performed (step S3).

b. Configuration of Poker Machine

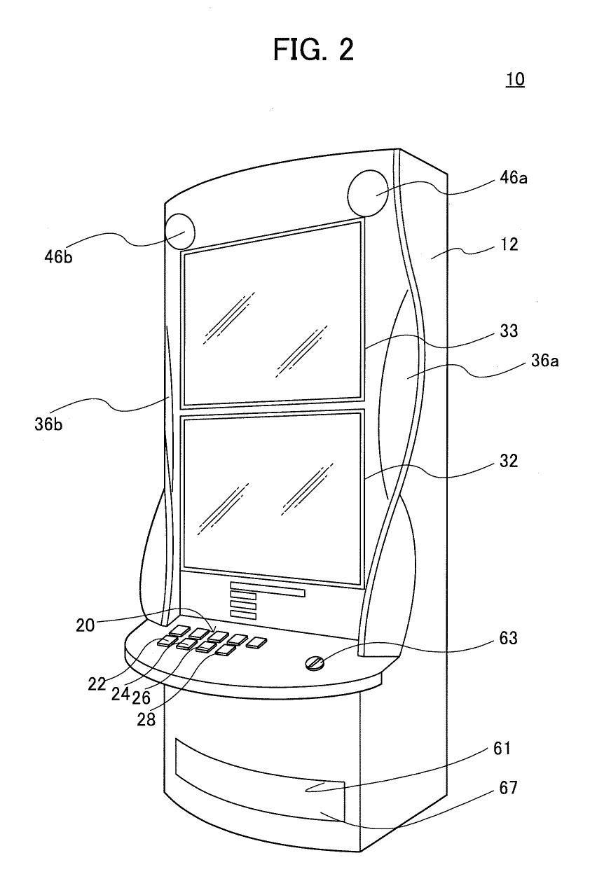

The general view of a gaming machine in the first embodiment of the invention is shown in FIG. 2. The present invention is described below by taking as an example a poker machine, which is suitably applicable to the gaming machine according to the present invention.

Specifically, the present embodiment relates to the poker machine using medals. However, the gaming machine of the present invention may be a gaming machine using, as a playing medium, coins, medals, tokens, or cards storing playing value information.

A first display 32 is disposed on the front of a poker machine 10. A second display 33 is disposed above the first display 32 on the front of the poker machine 10. The first display 32 displays cards distributed to a player, and an award table showing card combinations corresponding to any award. The second display 33 displays images of rendered effects. The first and second displays 32 and 33 are liquid crystal displays of touch-panel type.

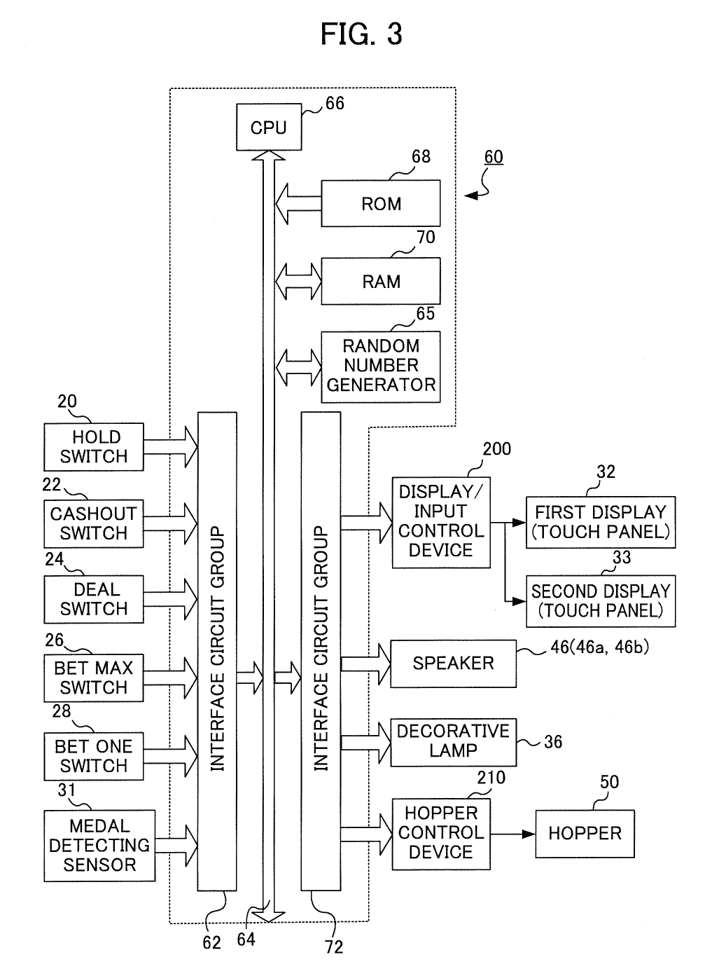

A medal slot 63 is disposed in the vicinity to the right on the front of the poker machine 10, and a medal payout opening 61 and a medal receiving pan 67 are disposed below the front. The player's medal insertion into the medal slot 63 enables gaming. Based on the game result, medals are paid out from the medal payout opening 61, and stored in the medal receiving pan 67. As is described later, a medal detecting sensor 31 (refer to FIG. 3) is housed inside the gaming machine where the medal slot 63 is disposed. The medal detecting sensor 31 detects insertion of medals by the player into the poker machine 10.

Decorative lamps 36a and 36b are disposed on the opposite sides of the poker machine 10, respectively. Speakers 46a and 46b are disposed in upper sections of the poker machine 10. The speakers 46a and 46b generate sounds effects, etc. in response to the game progress.

Various switches used for advancing a game are arranged below the first display 32.

A bet max switch 26 and a bet one switch 28 are used when the player starts the game. The bet one switch 28 increases the number of medals used for the game depending on the number of times the switch is pressed. The bet max switch 26 is used to bet five medals, namely the maximum number of medals, at a time.

A deal switch 24 and a cash out switch 22 are disposed on the left of the bet max switch 26. Five hold switches 20 are arranged above the bet max switch 26. The deal switch 24 is used when the player requests a display of cards. The player's operations of inserting medal(s) and pressing the deal switch 24 enable the images of distributed cards and new exchanged cards to be displayed on the first display 32.

The cash out switch 22 is used to pay out medals stored (hereinafter referred to as credited) in the poker machine 10. When the player activates the cash out switch 22 by a pressing operation, medals are paid out to the medal receiving pan 67.

The total number of the hold switches 20 is five. The hold switches 20 are arranged so as to correspond to the card images displayed on the first display 32, respectively. The hold switches 20 are used when the player selects a card to remain without being exchanged, after the cards are displayed. When the player activates by pressing the hold switch 20 underlying the selected card in the five cards displayed on the first display 32, the selected card remains unexchanged.

c. Configuration of Controller of Poker Machine

A control circuit of the poker machine as the present embodiment of the invention is shown in the block diagram of FIG. 3.

A main control circuit 60 as a controller is configured by connecting, through an input/output bus 64, a central processing unit (hereinafter referred to as a CPU) 66, read only memory (hereinafter referred to as ROM) 68, random access memory (hereinafter referred to as RAM) 70, a random number generator 65, and interface circuit groups 62 and 72 to each other. The input/output bus 64 inputs and outputs data signals, control signals or address signals to the CPU 66.

Based on a computer program stored in the ROM 68, the CPU 66 reads and writes data with respect to elements and units connected to the input/output bus 64, and cooperates with these elements and units to perform various types of processing. A timer (not shown) to be described later is housed within the CPU 66.

The medal detecting sensor 31 is connected to the interface circuit group 62 of the main control circuit 60. A detected signal from the medal detecting sensor 31 is converted to a predetermined signal by the interface circuit group 62, and then supplied to the input/output bus 64.

The deal switch 24 is also connected to the interface circuit group 62. The deal switch 24 transmits to the interface circuit group 62 a signal indicating an activation of the deal switch 24 by the player through a pressing operation, and this signal is then supplied to the input/output bus 64.

The hold switches 20, the cash out switch 22, the bet max switch 26 and the bet one switch 28 are also connected to the interface circuit group 62. When these switches are activated by the player's pressing operation, they transmit the corresponding signals indicating pressing operation to the interface circuit group 62. These detected signals are then supplied to the input/output bus 64.

The speakers 46 (46a and 46b) and the decorative lamps 36 (36a and 36b) are also connected to the interface circuit group 72. The interface circuit group 72 controls each of the abovementioned units by supplying a drive signal and drive power, in accordance with calculation processing performed in the CPU 66.

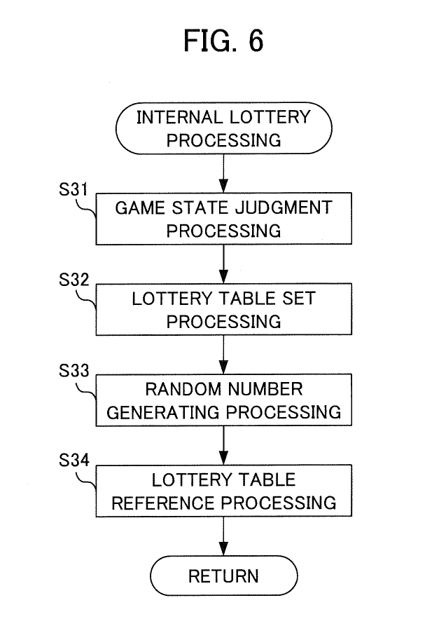

The ROM 68 and the RAM 70, each serving as a storage means, are also connected to the input/output bus 64. The ROM 68 stores a control program for controlling the entire flow of the game in the poker machine 10. The ROM 68 also stores the initial data for executing the control program, a program for controlling flash operation patterns of the decorative lamps 36 (36a and 36b (refer to FIG. 2)) housed within the poker machine 10, and a program for controlling display on the first display 32. The ROM 68 further stores, for example, a plurality of kinds of lottery tables for associating a random number sampled by the random number generator 65, with a card image to be displayed on the first display 32, and a combination judgment table for judging if a combination of patterns represented in a plurality of card images displayed on the first display 32 matches a specified combination. The plurality of lottery tables has different probabilities of winning outcomes. When a certain specified combination occurs, the CPU 66 sets a table for a high-probability win game having a higher probability of winning outcomes than a normal lottery table, as a lottery table for an internal lottery (refer to FIG. 6). The RAM 70 stores the values of flags and variables used in the abovementioned programs.

The random number generator 65 for generating random numbers is connected to the input/output bus 64. When an instruction for generating random numbers is transmitted from the CPU 66 to the random number generator 65, the random number generator 65 generates random numbers in a predetermined range, and transmits signals indicating the random numbers to the input/output bus 64. Based on the random numbers generated, the CPU 66 performs an internal lottery processing described later. The random numbers generated from the random number generator 65 are stored in the RAM 70.

In the present embodiment, the random number generator 65 connected via the input/output bus 64 to the CPU 66 samples the random numbers by way of example and without limitation. Alternatively, random number sampling may be executed under an operational program of the CPU 66. In this case, the random number generator 65 can be omitted.

A display and input controller 200 is also connected to the interface circuit group 72. Receiving an instruction for displaying an image sent from the main control circuit 60, the display and input controller 200 transmits drive signals indicative of driving the first display 32 and the second display 33, which are connected to the display and input controller 200. The display and input controller 200 also supplies input signals received from the first and second displays 32 and 33 to the interface circuit group 72, which are then transmitted to the CPU 66 via the input/output bus 64.

A hopper controller 210 is also connected to the interface circuit group 72. Receiving an instruction for paying out medals sent from the main control circuit 60, the hopper controller 210 transmits a drive signal for driving a hopper 50 connected to the hopper controller 210.

d. Operations of Poker Machine

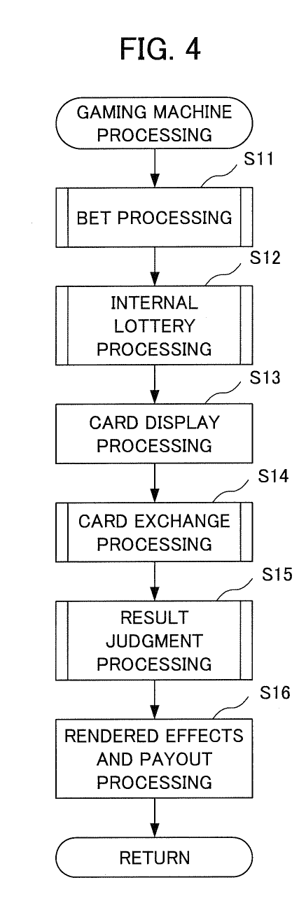

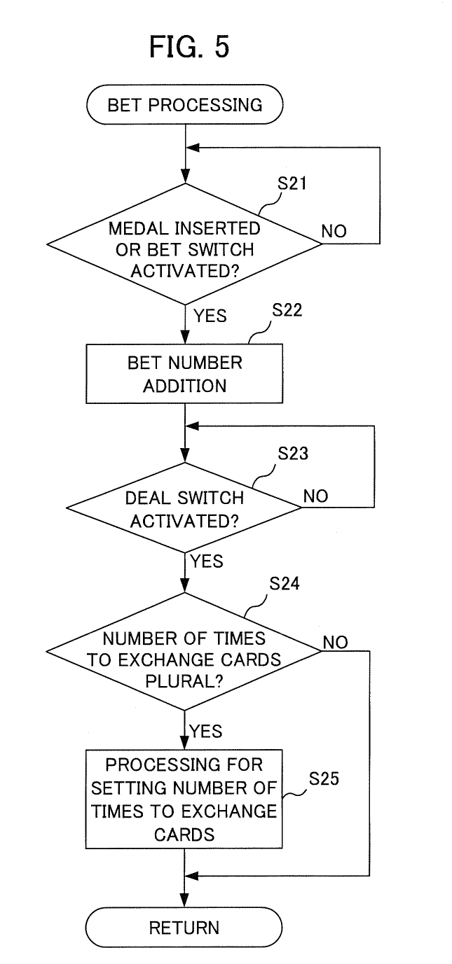

A main routine for controlling the poker machine 10, which is executed on the main control circuit 60, is shown in the flow chart of FIG. 4, and subroutines in the main routine are shown in the flow charts of FIGS. 5 to 11.

In the following, it is assumed that the poker machine 10 is activated in advance, and performs normal operation in a state in which the abovementioned random numbers used in the CPU 66 are initialized to predetermined values.

First, as shown in FIG. 4, the CPU 66 performs a bet processing (step S11).

In this processing, in response to the player's medal insertion, pressing the bet max switch 26 or pressing the bet one switch 28, the CPU 66 performs respective bet processing, accordingly. The details of the bet processing are described later. When the bet processing is terminated, the CPU 66 advances the process to step S12.

In step S12, the CPU 66 performs the internal lottery and executes processing for extracting a card. In this processing, the CPU 66 transmits an instruction for generating random numbers to the random number generator 65. Upon receipt of this instruction, the random number generator 65 samples random numbers. The random numbers generated by the random number generator 65 are then stored in the RAM 70 as random numbers indicating a lottery result. The CPU 66 refers to the lottery tables and determines the kinds of cards corresponding to the random numbers. The CPU 66 then stores the data of the kinds of the cards in the RAM 70. The details of the internal lottery processing are described later. When the internal lottery is terminated, the CPU 66 advances the process to step S13.

In step S13, the CPU 66 performs processing for displaying a card. The CPU 66 supplies the data of five cards to be initially distributed by way of display to the player from the cards determined by the internal lottery in step S12, and an instruction for displaying a card image to the display and input controller 200 via the input/output bus 64 and the interface circuit group 72. The display and input controller 200 reads out the corresponding image data and stores the data in a video RAM housed in the display and input controller 200. In this way, the first display 32 displays the five cards initially distributed to the player. When the high-probability win game is executed, a plurality of five-card sets is displayed on the second display 33. The details of the card display processing are described later. When the processing for displaying a card is terminated, the CPU 66 advances the process to step S14.

In step S14, the CPU 66 performs processing for exchanging a card. In this processing, the CPU 66 causes the first display 32 to display new card images thereon, in response to the player's card exchange operation. Before displaying the new card images, the CPU 66 judges if the patterns of the five cards to be displayed after an exchange will match a certain specified combination. Based on the judgment result, the CPU 66 changes a card display sequence. The details of this processing are described later. When the processing for exchanging a card is terminated, the CPU 66 advances the process to step S15.

In step S15, the CPU 66 judges if the patterns of the five cards displayed on the first display 32 after the exchange will match a card combination entitled to an award (for example, Two Pair, Three Card, Flush, etc.). The judgment is made referring to the combination judgment tables stored in the RAM 70. In the abovementioned processing for displaying a card, in order to change the card display sequence, the CPU 66 has already judged if the patterns of the five cards to be displayed after the exchange matches the specified combination, before the cards are displayed. However, if the judgment in the above processing in step S14 is made only with regard to the specified combination used for controlling the card display sequence, the CPU 66 performs another judgment in processing for judging a result in step S15. Namely, the CPU 66 determines which card combination entitled to an award is matched by a combination of patterns of the cards displayed after the exchange. In contrast, when the CPU 66 has performed judgment for not only the specified combination but also all of the card combinations entitled to an award in the processing for exchanging a card in step S14, it may be possible to use the judgment in step S14 without performing any new judgment in the present step S15. The details of this processing are described later. When the processing for judging a result is terminated, the CPU 66 advances the process to step S16.

In step S16, the CPU 66 performs processing for giving rendered effects and paying out. The CPU 66 performs this processing, in accordance with the judgment result in step S15. Specifically, when the CPU 66 determines matching of a card combination entitled to an award, the CPU 66 causes the first display 32 to display the card combination, and also causes the number of medals obtained by the player to be added to the number of credits. When the number of credits exceeds 50, the exceeding number of medals is paid out through the medal payout opening 61 to the medal receiving pan 67. On the other hand, when the judgment result is the absence of any card combination matching an award, the CPU 66 causes the first display 32 to display notification of the absence of any worth card combination. When the CPU 66 finishes the processing for giving rendered effects and paying out, it terminates the main routine.

As described above, the CPU 66 performs processing for controlling the win game, through step S11 and step S12, and through step S15 and step S16.

e. Bet Processing

In step S11 (FIG. 4), a bet processing subroutine shown in FIG. 5 is called.

Firstly, the CPU 66 performs processing to judge if medals have been inserted, or the bet switch has been activated (step S21).

In this processing, the CPU 66 determines whether or not it has received one of the following signals: a signal indicating an insertion of medals into the medal slot 63 sent from the detecting sensor 31, a signal indicating an activation of the bet max switch 26, and a signal indicating an activation of the bet one switch 28. If the CPU 66 determines the reception of one of the signals, it advances the process to step S22. Otherwise, the CPU 66 repeats step S21.

In step S22, the CPU 66 performs processing for adding a bet number. In this processing, the CPU 66 adds the number of credits in accordance with the result in step S21. That is, the CPU 66 stores as a bet number, in the RAM 70, the sum of the number of detections of medal insertion and the number of times the bet one switch 28 has been activated. The maximum bet number is “5”. When the bet max switch 26 is activated, the maximum value of “5” is stored in the RAM 70, irrespective of the number of detections of medal insertion and the number of times the bet one switch 28 has been activated. When the bet number addition processing is terminated, the CPU 66 advances the process to step S23.

In step S23, the CPU 66 performs processing to judge if the deal switch 24 has been activated. In this processing, the CPU 66 judges if it has received a detection signal indicating an activation of the deal switch 24. If not, the CPU 66 repeats step S23. If so, the CPU 66 advances the process to step S24.

In step S24, the CPU 66 performs processing to judge if it is possible to set a plural exchange number. In this processing, the CPU 66 refers to an exchange number counter stored in the RAM 70. If the value of the exchange number counter is at least 2, the CPU 66 judges setting a plurality exchange number as being possible. If so, the CPU 66 advances the process to step S25. If not, the CPU 66 terminates the present subroutine.

In step S25, the CPU 66 performs processing to set an exchange number. In this processing, the CPU 66 causes the second display 33 to display a screen for setting an exchange number. Furthermore, in response to a control signal generated by the player touching the second display 33, the CPU 66 causes the RAM 70 to store the card exchange number set for the win game in the value of a residual exchange number counter. When this processing is terminated, the CPU 66 terminates the present subroutine.

f. Internal Lottery Processing

In the abovementioned step S12 (FIG. 4), the internal lottery processing sub routine as shown in FIG. 6 is called.

In step S31, the CPU 66 performs processing for judging a game state. In this processing, the CPU 66 performs processing to judge the game state based on a game state flag stored in the RAM 70. When this processing is terminated, the CPU 66 advances the process to step S32.

In step S32, the CPU 66 performs processing for setting a lottery table. In this processing, based on the game state as judged in step S31, the CPU 66 selects a lottery table in accordance with the game state, from a plurality of kinds of tables having different winning probabilities stored in the ROM 68, and sets the selected table in the RAM 70. When this processing is terminated, the CPU 66 advances the process to step S33.

In step S33, the CPU 66 performs processing for generating a random number. In this processing, the CPU 66 transmits an instruction for generating a random number to the random number generator 65. Upon receipt of the instruction, the random number generator 65 samples random numbers. The random numbers generated by the random number generator 65 are stored in the RAM 70 as random numbers indicating a lottery result. When this processing is terminated, the CPU 66 advances the process to step S34.

In step S34, the CPU 66 performs processing for setting a combination. In this processing, the CPU 66 refers to the lottery table set in step S32, and selects a combination of cards to be distributed corresponding to the random numbers stored in the RAM 70 in step S33. The CPU 66 then stores the data of the kinds of the cards in the RAM 70. When this processing is terminated, the CPU 66 terminates the present subroutine. When the CPU 66 also refers to the high-probability flag to find a high-probability state, the CPU 66 selects a special winning combination (for example, Two Pair) as a distributed card combination.

In the above processing, ten cards are extracted from the cards of the deck usable in the game. Among the ten cards, five cards are initially displayed to the player, and the remaining five cards can be displayed to the player by card exchange. The initial five cards displayed to the player are invariably displayed on the first display 32. Whereas among the five cards that are displayed by card exchange, only the desired cards are displayed on the first display 32 when the player desires the card exchange. In the present embodiment, the cards used for exchange are selected by lottery in advance, at the same time as the lottery of the cards initially displayed to the player. Alternatively, after a card exchange number has been determined, the determined number of cards may be selected by lottery.

g. Processing for Exchanging a Card

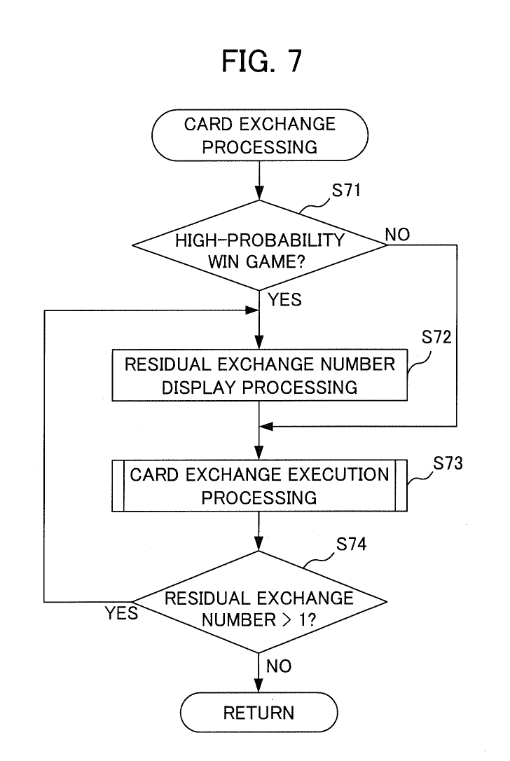

In the abovementioned step S14 (FIG. 4), a sub-routine of processing for exchanging a card as shown in FIG. 7 is called.

In step S71, the CPU 66 performs processing to judge if a game is in the high probability mode. If judged so, the CPU 66 advances the process to step S72. If not, the CPU 66 advances the process to step S73.

In step S72, the CPU 66 performs processing for displaying a residual exchange number. In this processing, the CPU 66 performs processing to display a residual exchange number on the second display 33. When this processing is terminated, the CPU 66 advances the process to step S73.

In step S73, the CPU 66 performs processing for executing a card exchange. This processing is described later. When this processing is terminated, the CPU 66 advances the process to step S74.

In step S74, the CPU 66 performs processing to judge if the residual exchange number exceeds 1. In this processing, the CPU 66 judges if the remaining exchange number exceeds 1, by referring to the remaining exchange number counter in the RAM 70. If judged so, the CPU 66 advances the process to step S72. If not, the CPU 66 terminates the present subroutine.

h. Processing for Exchanging a Card

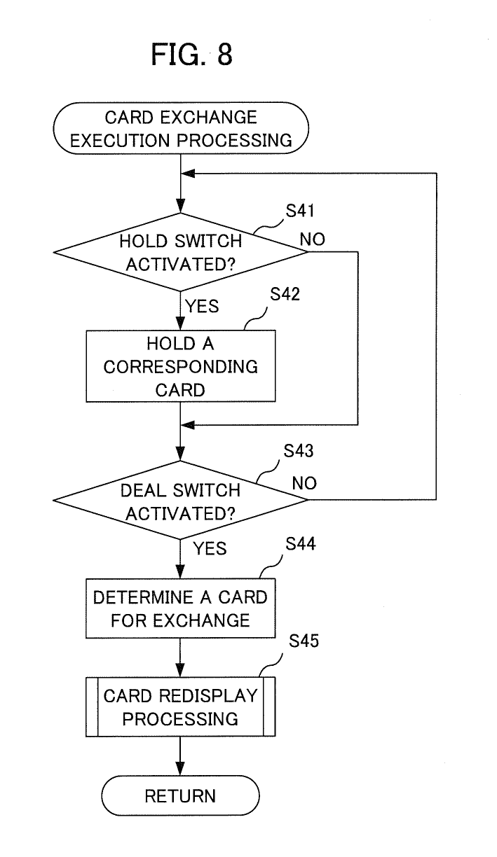

In the abovementioned step S73 (FIG. 7), a sub-routine of processing for exchanging a card as shown in FIG. 8 is called.

Firstly, the CPU 66 performs processing to judge if any one of the hold switches 20 has been activated (step S41).

In this processing, the CPU 66 judges if it has received a detection signal indicating any one of the five hold switches 20 having been activated. If not, the CPU 66 advances the process to step S43. If so, the CPU 66 advances the process to step S42.

In step S42, the CPU 66 performs processing to hold the corresponding card. In this processing, the CPU 66 configures so that the card corresponding to the hold switch 20 activated in step S41 cannot be exchanged, even after the deal switch 24 is activated. The CPU 66 also causes the first display 32 to display “HOLD” below the image of the corresponding card on the first display 32. When the hold of the corresponding card is terminated, the CPU 66 advances the process to step S43.

In step S43, the CPU 66 performs processing to judge if the deal switch 24 has been activated. In this processing, the CPU 66 judges if it has received a detection signal indicating the deal switch 24 having been activated. If not, the CPU 66 advances the process to step S41. If so, the CPU 66 advances the process to step S44.

In step S44, the CPU 66 performs processing to determine a card for exchange. In this processing, the CPU 66 determines the number of cards not being held, namely the number of cards the player desires for exchange, from the five cards selected by lottery in the abovementioned step S12 (FIG. 4) so as to be displayed to the player by card exchange. It may be alternatively possible that the CPU 66 determines cards to be exchanged by lottery from the five cards in the present step S44. Furthermore, it may be alternatively possible that the CPU 66 selects cards to be used for exchange from the five cards according to ranking, which the CPU 66 assigns to these five cards in the lottery in step 12 (FIG. 4). In some cases, the player may desire to exchange the five cards, namely all the cards in hand. When the determination of card exchange is terminated, the CPU 66 advances the process to step S45.

In step S45, the CPU 66 performs processing for redisplaying a card. In this processing, the CPU 66 transmits the data of the kind of the exchanged card determined in step S34, to the display and input controller 200, which controls the first display 32 to display an image of the exchanged card in place of that not held in the five cards. The details of this processing are described later. When the processing for redisplaying a card is terminated, the CPU 66 terminates the present subroutine.

i. Processing for Redisplaying a Card

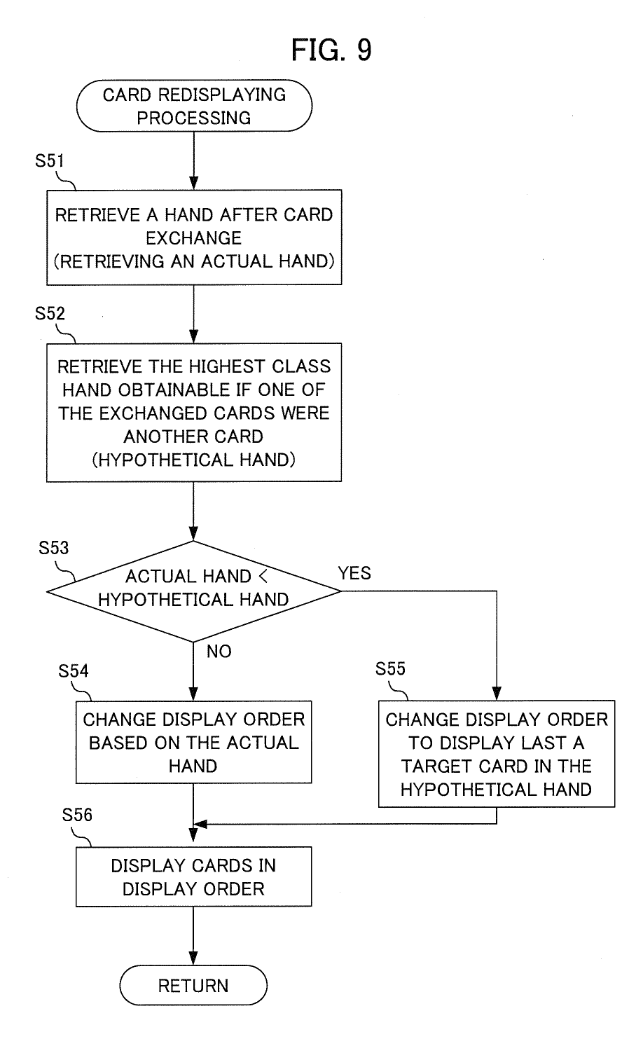

The processing for redisplaying a card called in step S45 (FIG. 8) is described below with reference to FIG. 9. More specifically, a description is made of a case, for example: the cards of a “10 of Spades,” a “Jack of Spades,” a “Queen of Spades,” a “3 of Diamonds” and a “2 of Diamonds” are displayed firs; the player selects the cards of the “10 of Spades,” the “Jack of Spades” and the “Queen of Spades” as hold cards; and a “Jack of Diamonds” and a “King of Spades” are determined by lottery as cards to be exchanged with the remaining two cards.

First, the CPU 66 retrieves a hand achieved by the combination of the held cards and the exchanged cards (step S51). Since this hand is settled when the card exchange is terminated, it is referred to as an actual hand. Based on the combination of the held cards and the exchanged cards, the CPU 66 retrieves the hands stored in the ROM 68.

The poker hands such as Royal Flush and Straight Flush are stored in the ROM 68, along with the respective poker hand class data. More specifically, a poker hand class indicates the number of medals paid out in accordance with a card combination entitled to a predetermined award in the award table displayed on the first display 32 during the win game when the player bets a medal. For example, the hand class of Royal Flush is 500, the hand class of Straight Flush is 50, and the hand class of Four of A Kind is 20. In this case, a larger numeral value represents a higher hand class. Alternatively, the poker hand classes may be ordinal numbers such as “1,” “2,” and “3,” which represent the respective poker hand orders. The CPU 66 retrieves a possible highest poker hand stored in the ROM 68 for the combination of the newly displayed cards by exchange and the held cards. In the present embodiment, as the result of the card exchange, one pair of a “Jack of Spades” and a “Jack of Diamonds” is retrieved as an actual hand.

In the succeeding step S52, the CPU 66 retrieves a highest hand obtainable if one of the exchanged cards were another card, in the combination of the held cards and the exchanged cards. This hand is a hypothetical hand not actually achieved. Assuming that the “Jack of Diamonds” as one of the exchanged cards are another kind of card, the CPU 66 first retrieves a highest hand obtainable with the exchanged card and the held cards. More specifically, the CPU 66 retrieves the highest hand by exchanging the card of the “Jack of Diamonds” with other cards in sequence, and retrieving the corresponding hand for each of the changed cards. In the present embodiment, it is assumed that changing the “Jack of Diamonds” to the “Ace of Spades” results in a Royal Flush hand.

Subsequently, the CPU 66 retrieves a highest hand by changing the exchanged card of the “King of Spades” to other cards in sequence. In the present embodiment, changing the “King of Spades” to the “Queen of Diamonds” results in a two pair hand of “Jacks” and “Queens.” Since the Royal Flush hand has a higher class than the Two Pair hand, the Royal Flush hand with the “Jack of Diamonds” as a target card can be retrieved as the highest hypothetical hand.

Next, the CPU 66 makes comparison in class between the actual hand obtained in step S51 and the hypothetical hand obtained in step S52 (step S53). If the class of the hypothetical hand is higher than the class of the actual hand, the CPU 66 advances the process to step S55. If the class of the hypothetical hand is equal to or lower than the class of the actual hand, the CPU 66 advances the process to step S54.

In step S54, the CPU 66 changes the display order based on the actual hand. For example, if the actual hand is a one pair hand of the “Jack of Spades” and the “Jack of Diamonds,” the “Jack of Diamonds” of the exchanged card is displayed first.

On the other hand, in step S55, the CPU 66 changes the display order based on the hypothetical hand. Specifically, the CPU 66 changes the display order such that the target card to complement the hypothetical hand is displayed last. In the present embodiment, since the target card for achieving the Royal Flush as the hypothetical hand is a “Jack of Diamonds” card, the display order is changed so that the last card to be displayed is the “Jack of Diamonds.”

In the succeeding step S56, the CPU 66 controls a display of the exchanged cards in accordance with the display order. Specifically, the CPU 66 first supplies an instruction for displaying an image of the first exchanged card to the display and input controller 200 via the input/output bus 64 and the interface circuit group 72. The display and input controller 200 reads out the desired image data, and stores the data in the video RAM within the display and input controller 200. In this way, the first display 32 displays the exchanged cards. Subsequently, the CPU 66 performs a delay processing for a predetermined time such as 0.2 seconds to 2 seconds. And it transmits an instruction for displaying an image of the second exchanged card to the display and input controller 200, thereby causing the first display 32 to display the second exchanged card. Then, the CPU 66 causes the first display 32 to display the exchanged cards in sequence, with the delay processing in between.

By the successive display of the exchanged cards, for example, in the two exchanged cards facing down, the first one is faced up displaying the “King of Spades.” This enables the player to expect that a Royal Flush may be achieved when the other exchanged card not yet displayed is the “Ace of Spades.” In fact, the changed card of the “Jack of Diamonds” is then displayed, so that a one pair hand is merely achieved as an actual hand.

Thus, changing the order of displaying exchanged cards based on the hypothetical hand enables the player to keep expecting a certain hand achievement until the last exchanged card is displayed. After this processing, the CPU 66 terminates the present subroutine.

j. Processing for Judging a Result

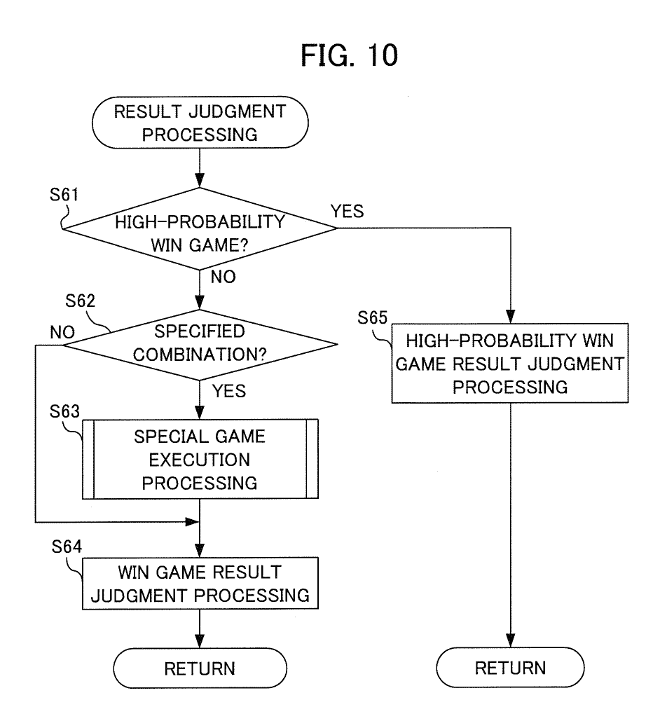

The processing for judging a result called in step S14 (FIG. 4) is described with reference to FIG. 10.

In step S61, the CPU 66 performs processing to judge if the game is in a high-probability mode. If judged so (the value of the high-probability flag is 1) based on the value of the high-probability flag stored in the RAM 70, the CPU 66 advances the process to step S65. If not, the CPU advances the process to step S62.

In step S62, the CPU 66 performs processing to judge if the combination is a specified combination. If so (for example, Flush of Hearts or Diamonds), the CPU 66 advances the process to step S63. If not, the CPU advances the process to step S64.

In step S63, the CPU 66 performs processing for executing a special game. This processing is described later. When this processing is terminated, the CPU 66 advances the process to step S64.

In step S64, the CPU 66 performs processing to judge a win game result. In this processing, when the CPU 66 determines that the win game result is worth a payout number, the CPU 66 controls the payout number to be stored in the RAM 70. When this processing is terminated, the CPU 66 terminates the present subroutine.

In step S65, the CPU 66 performs processing to judge a result of a high-probability win game. In this processing, when the CPU 66 determines that the high-probability game result is worth a payout number, the CPU 66 controls the payout number to be stored in the RAM 70. When this processing is terminated, the CPU 66 terminates the present subroutine.

k. Processing for Executing a Special Game

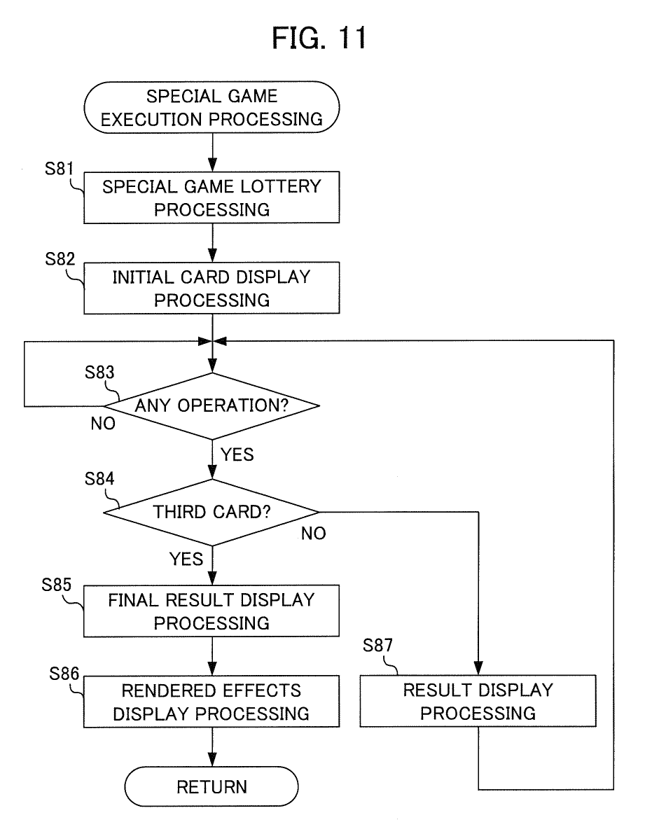

Processing for executing a special game called in step S63 (FIG. 10) is described with reference to FIG. 11.

In step S81, the CPU 66 performs processing for executing a special game lottery. More specifically, the CPU 66 performs processing to sample random numbers and refer to the lottery tables stored in the ROM 68 so as to determine a deck number, etc. to be supplied in the special game. When this processing is terminated, the CPU 66 advances the process to step S82.

In step S82, the CPU 66 performs processing for displaying an initial card. In this processing, the CPU 66 supplies an instruction for displaying images of the back faces of a plurality of cards to the display and input controller 200 via the input/output bus 64 and the interface circuit group 72. The display and input controller 200 reads out the corresponding image data, and controls the data to be stored in the video RAM within the display and input controller 200. In this way, the second display 33 displays the back faces of cards initially distributed to the player in the special game. When this processing is terminated, the CPU 66 advances the process to step S83.

In step S83, the CPU 66 performs processing to judge if any operation has been made. In this processing, the CPU 66 judges if the player initiated a certain operation, receiving a detection signal from the second display 33 in response to the player's touch operation on the screen of the second display 33. If so, the CPU 66 advances the process to step 84. If not, the CPU 66 advances the process to step 83. Even if the CPU 66 does not judge that an operation has been initiated, the CPU 66 advances the process to step S84 after an elapse of a predetermined time (for example, 10 seconds).

In step S84, the CPU 66 performs processing to judge if it is the third card. In this processing, if the CPU determines that it is the third card turned over (by the player's touch operation on the second display 33), the CPU 66 advances the process to step S85. If not, the CPU 66 advances the process to step S87.

In step S85, the CPU 66 performs processing for displaying a final result. In this processing, the CPU 66 supplies an instruction for displaying an image of the final result (the face-up three cards) to the display and input controller 200 via the input/output bus 64 and the interface circuit group 72. The display and input controller 200 reads out the corresponding image data and controls the data to be stored in the video RAM within the display and input controller 200. This enables the second display 33 to display the final result. When this processing is terminated, the CPU 66 advances the process to step S86.

In step S86, the CPU 66 performs processing for displaying rendered effects. In this processing, the CPU 66 transmits an instruction for displaying an image of the rendered effects (for example, an erupting volcano image, etc.) to the display and input controller 200 via the input/output bus 64 and the interface circuit group 72. The display and input controller 200 reads out the corresponding image data, and controls the data to be stored in the video RAM within the display and input controller 200. This enables the second display 33 to display the image of the rendered effects. When this processing is terminated, the CPU 66 terminates the present subroutine.

In step S87, the CPU 66 performs processing for displaying a result. In this processing, the CPU 66 transmits an instruction for displaying an image of a result (for example, the face-up cards, etc.) to the display and input controller 200 via the input/output bus 64 and the interface circuit group 72. The display and input controller 200 reads out the corresponding image data, and controls the data to be stored in the video RAM within the display and input controller 200. This enables the second display 33 to display the image of the result. When this processing is terminated, the CPU 66 advances the process to step S83.

Thus, the CPU 66 is an example of a controller which executes the win game. In the win game, a card selected by a player from a plurality of cards distributed initially is exchanged with another card. The player wins a predetermined award if the cards distributed finally include a plurality of cards matching a specified combination. The CPU 66 is also an example of a controller performing a plurality of times the high-probability win game, which increases the probability of winning in the next succeeding game when a combination of finally distributed cards matches a specified combination. The CPU 66 is also an example of a controller which performs, prior to execution of the high-probability win game, a special game for determining an allowable number of card exchanges in the high-probability win game. Thus, the allowable number of card exchanges is the total number in the high-probability win games continuously performed a plurality of times. Accordingly, the CPU 66 is an example of a controller which manages the allowable number of card exchanges to be consumed in the high-probability win games. Thus, the first display 32 is an example of a display which displays the images related to the high-probability win game, under the control of the controller.

### 1. Displays on Poker Machine

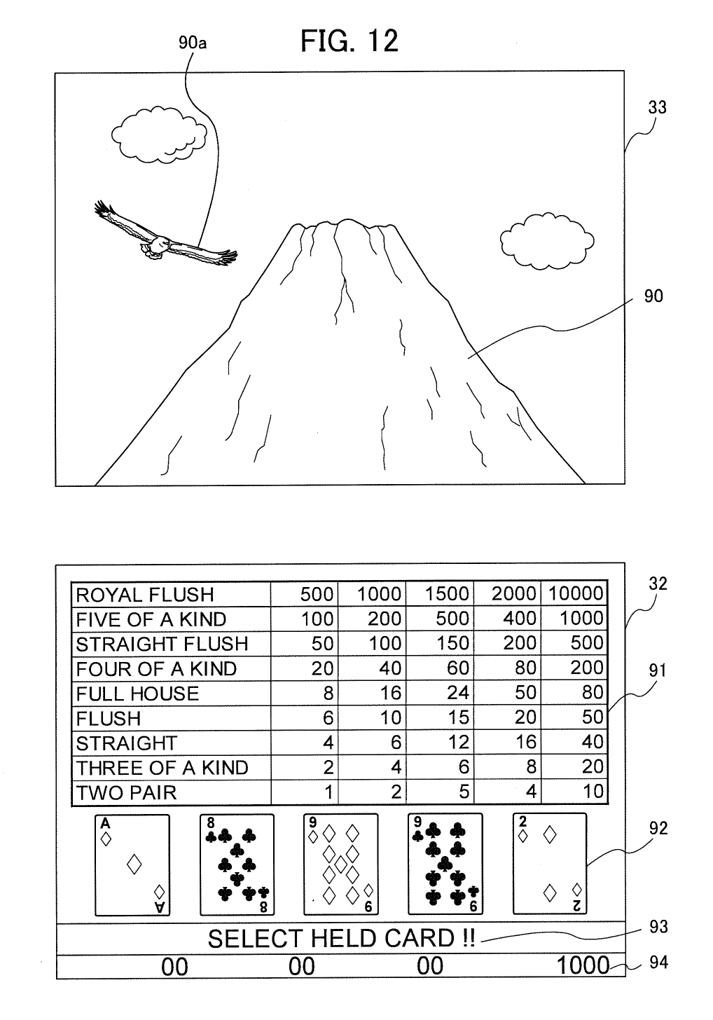

FIG. 12 is a schematic diagram illustrating an example of display screens. As shown in FIG. 12, a graphic image 90 (for example, a volcano image, etc.) is displayed on the second display 33. A graphic 90a (for example, a flying eagle image, etc.) is also displayed on the second display 33. A graphic image 91 (for example, a poker award table image, etc.) is displayed on the first display 32. A graphic image 92 (for example, a plurality of card images, etc.) is also displayed on the first display 32. A character image 93 (for example, “SELECT HELD CARD!!”, etc.) is also displayed on the first display 32. A character image 94 indicating a point (for example, “0000 00 1000”, etc.) is also displayed on the first display 32.

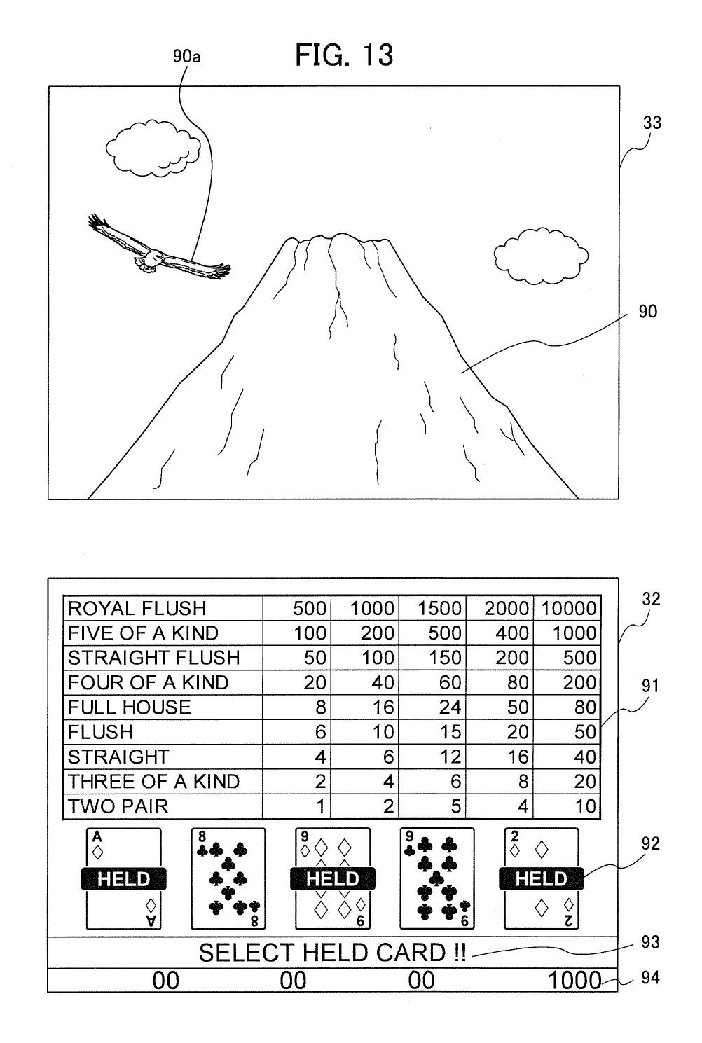

FIG. 13 is a schematic diagram illustrating an example of display screens after the hold switch is pressed on the screen as shown in FIG. 12. A graphic image 92 (for example, a plurality of card images, including a card on which the graphic image of “HELD” is superimposed) is also displayed on the first display 32.

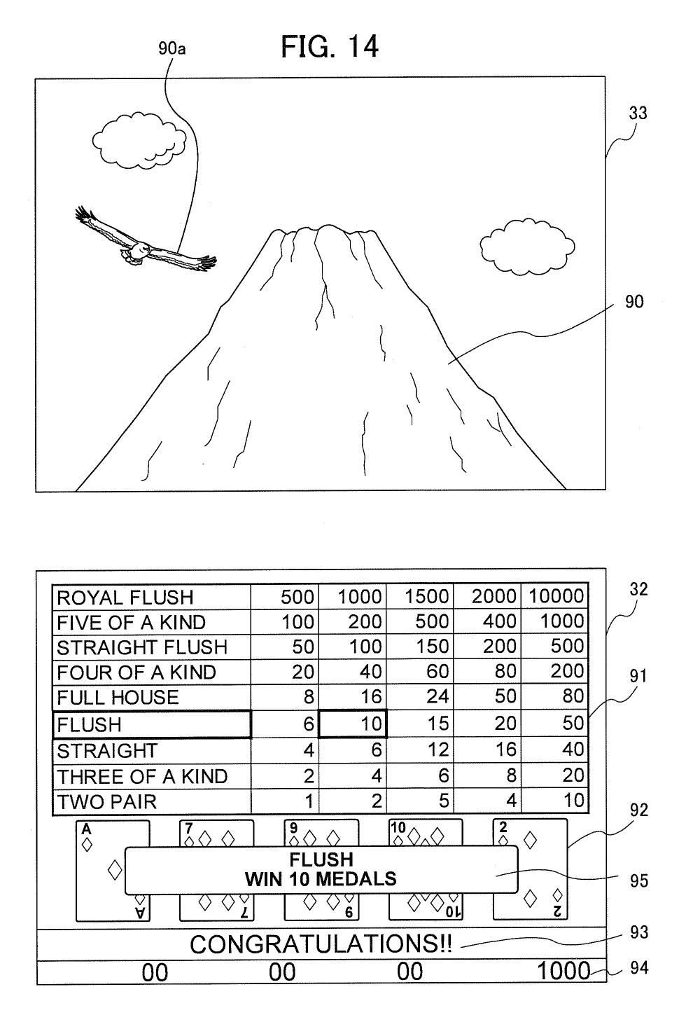

FIG. 14 is a schematic diagram illustrating an example of display screens after the deal switch is pressed on the screen as shown in FIG. 13. A graphic image 91 (for example, a poker award table image having the highlighted “Flush” and “10”, etc.) is displayed on the first display 32. A character image 93 (for example, “CONGRATULATIONS!!”, etc.) is also displayed on the first display 32. A character image 95 (for example, “FLUSH WIN 10 MEDALS”, etc.) is also displayed on the first display 32.

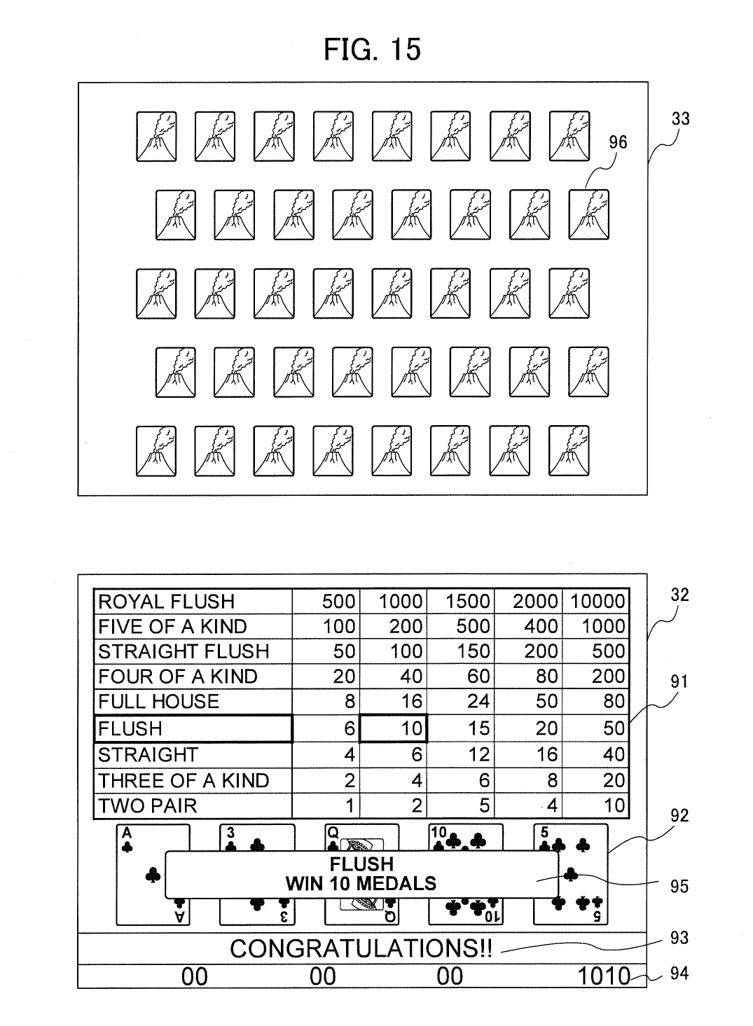

FIG. 15 is a schematic diagram illustrating an example of display screens when a special game starts with a specified combination (Flush (refer to FIG. 14)). As shown in FIG. 15, a graphic image 96 (for example, a plurality of cards bearing volcano images on their back faces, respectively) is displayed on the second display 33. A character image 93 (for example, “CONGRATULATIONS!!”, etc.) is also displayed on the first display 32.

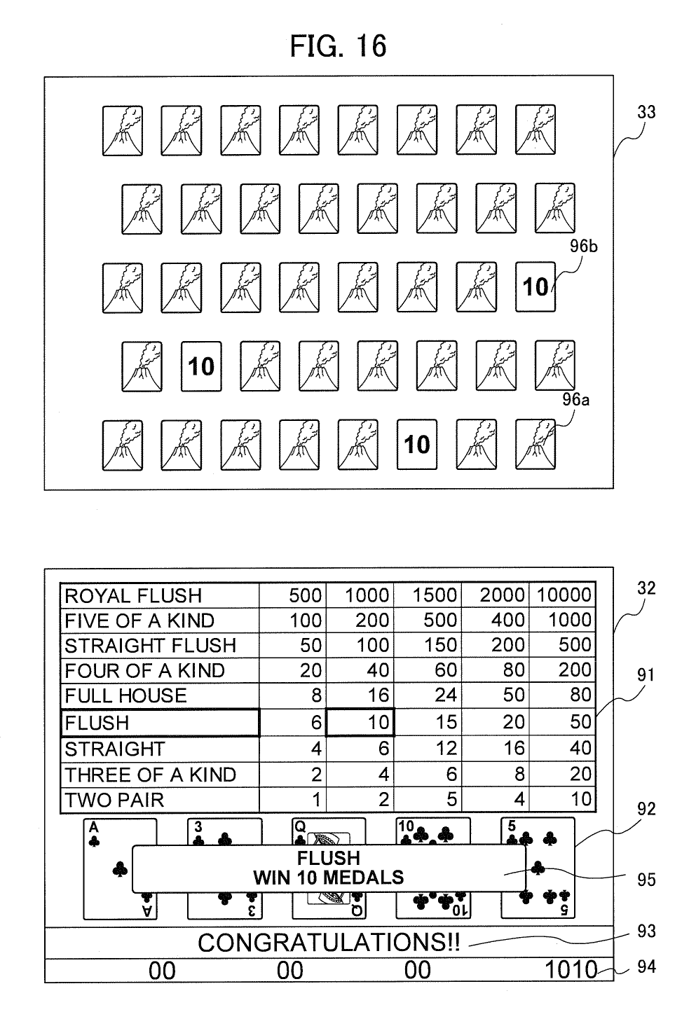

FIG. 16 is a schematic diagram illustrating an example of display screens in the special game after the player has touched a card image on the second display 33. A graphic image 96b (for example, three cards bearing “10” on their respective rear faces) is displayed on the second display 33. Thus, the number of decks based on the result of the special game (for example, a card game of gathering pairs of cards bearing the same number or face (e.g., 25)) can be provided in the high-probability win game displayed on the second display 33.

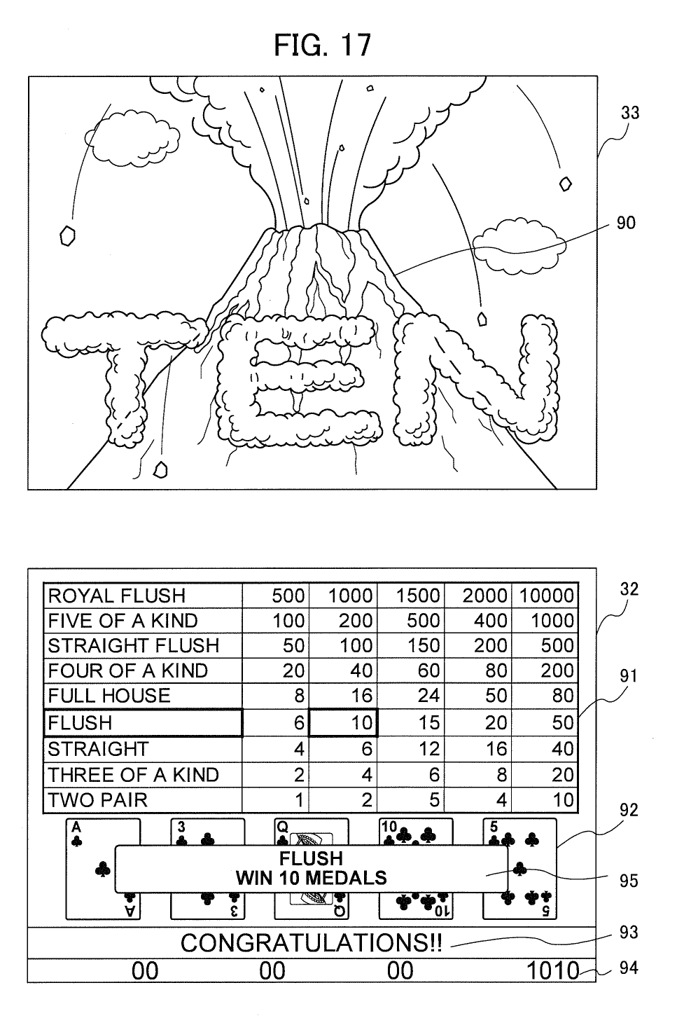

FIG. 17 is a schematic diagram illustrating an example of display screens after the special game is terminated. A graphic image 90b (for example, a volcanic smoke image in the shape of “TEN”) is displayed on the second display 33. For example, the volcanic smoke as in the graphic image 90b (for example, the numbers of 1 to 25 expressed by volcanic smoke) are used to show the player the number of decks displayed on the second display 33 in the high-probability win game.

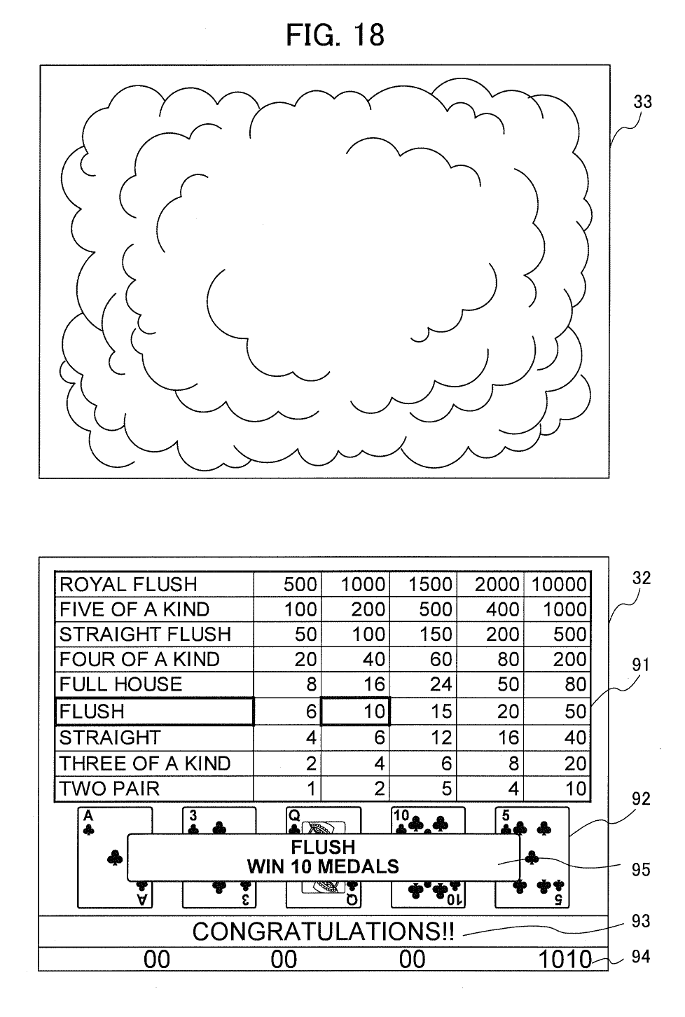

FIG. 18 is a schematic diagram illustrating an example of display screens after the special game is terminated. As shown in FIG. 18, a graphic image 90c (for example, an image where the smoke spreads completely) after the completion of the number of eruptions corresponding to the number of games awarded to the high-probability win game is displayed on the second display 33.

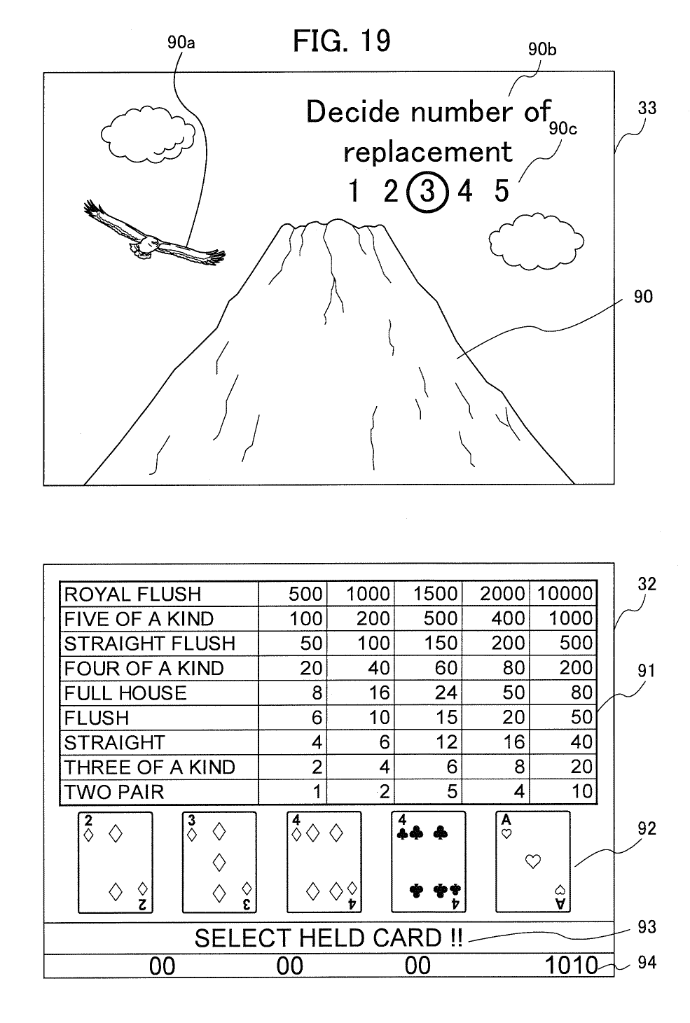

FIGS. 19 to 22 are schematic diagrams illustrating display screens in the high-probability win game. FIG. 19 is a schematic diagram illustrating an example of display screens when the high-probability win game is started. Upon the termination of the graphic image display of the volcanic smoke as shown in FIG. 18, a graphic image 90 (for example, a volcano image, etc.) is displayed on the second display 33, as shown in FIG. 19. A graphic 90a (for example, a flying eagle image, etc.) is also displayed on the second display 33. A character image 90b (for example, “Decide number of exchange”, etc.) is displayed on the second display 33. A graphic image 90c (for example, an image where a numeral indicating a exchange number is circled in the image of a plurality of numerals) is displayed on the second display 33. The player can set a card exchange number in the current win game by touching the graphic image 90c displayed on the second display

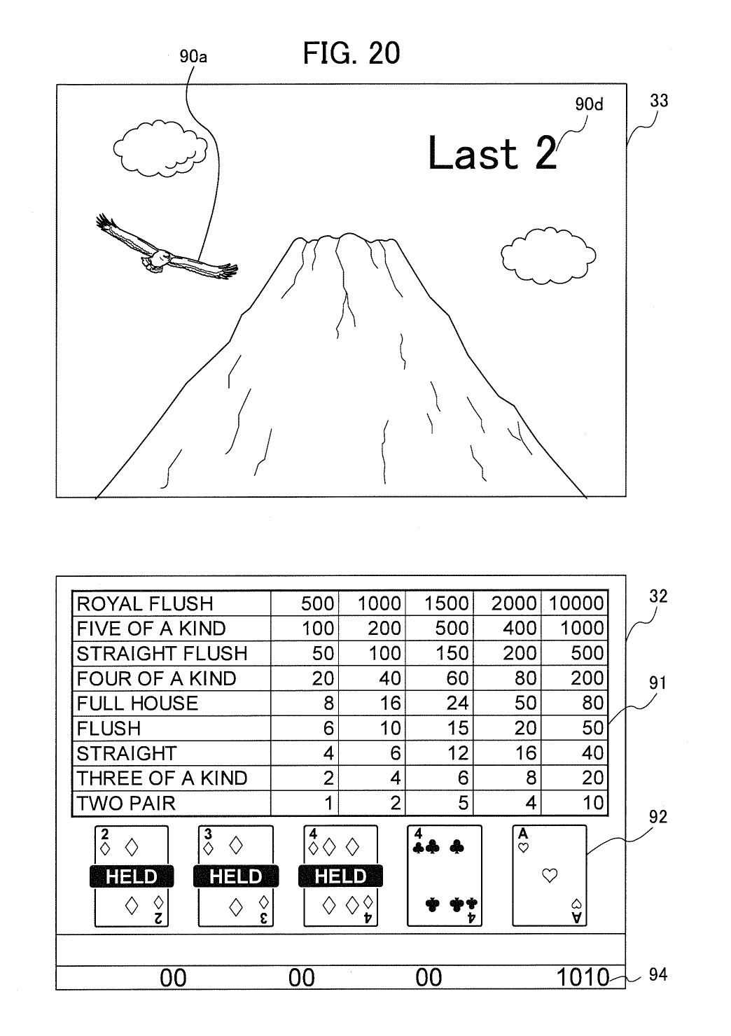

FIG. 20 is a schematic diagram illustrating an example of display screens after the card exchange. A character image 90d (for example, Last 2, etc.), expressing the residual card exchange number, is also displayed on the second display 33. A graphic image 92 (for example, a plurality of card images, including a card on which a graphic image of “HELD” is superimposed) is also displayed on the first display 32. The display of the character image 90d enables the player to see that the remaining card exchange number is two.

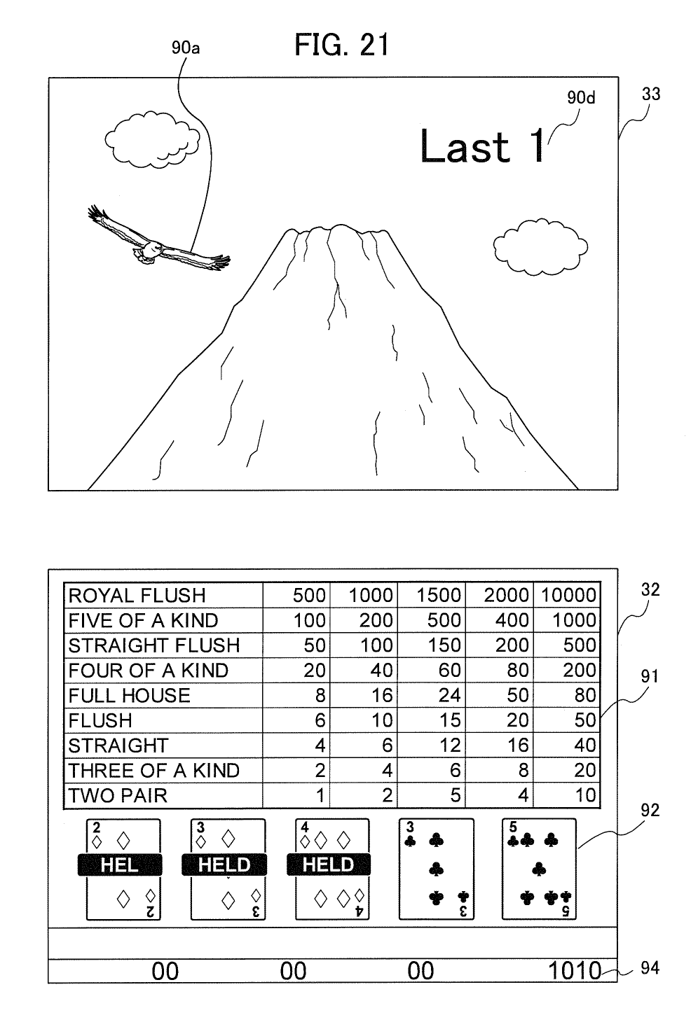

FIG. 21 is a schematic diagram illustrating an example of display screens after the card exchange. A character image 90d (for example, Last 1, etc.), expressing the remaining card exchange number, is also displayed on the second display 33.

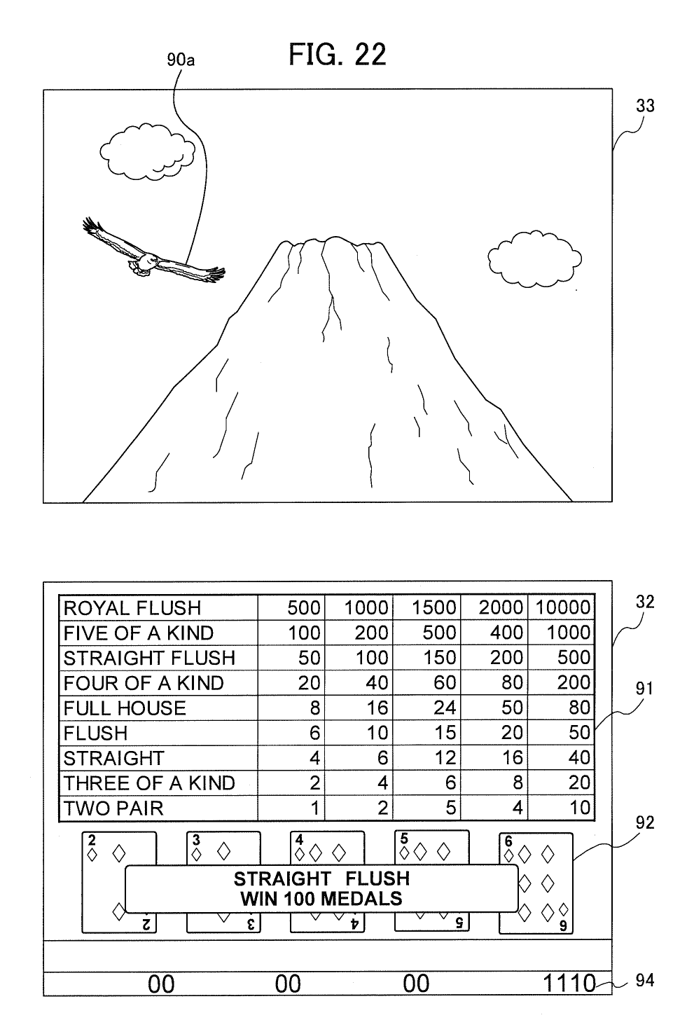

FIG. 22 is a schematic diagram illustrating an example of display screens displaying the results of the win game. A graphic image 92 (for example, card images corresponding to Flush of Diamonds) is also displayed on the first display 32. A character image 94, indicating a point (for example, “0000 00 1110”, etc.), is also displayed on the first display 32. A character image 95 (for example, “STRAIGHT FLUSH WIN 100 MEDALS”, etc.) is also displayed on the first display 32.

### SECOND EMBODIMENT

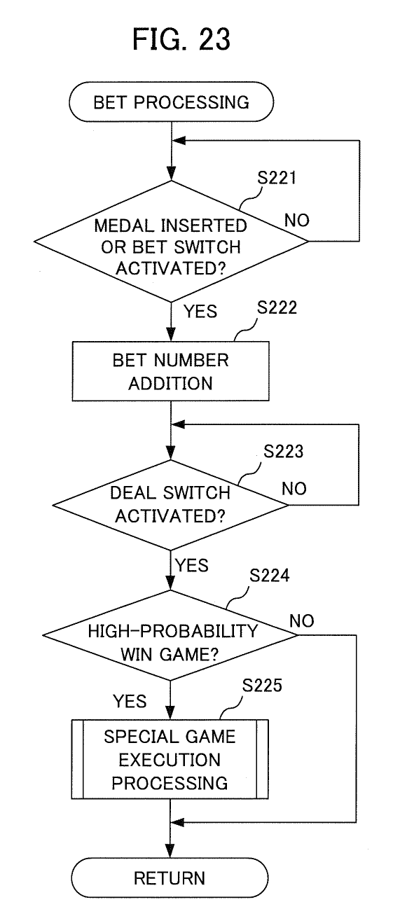

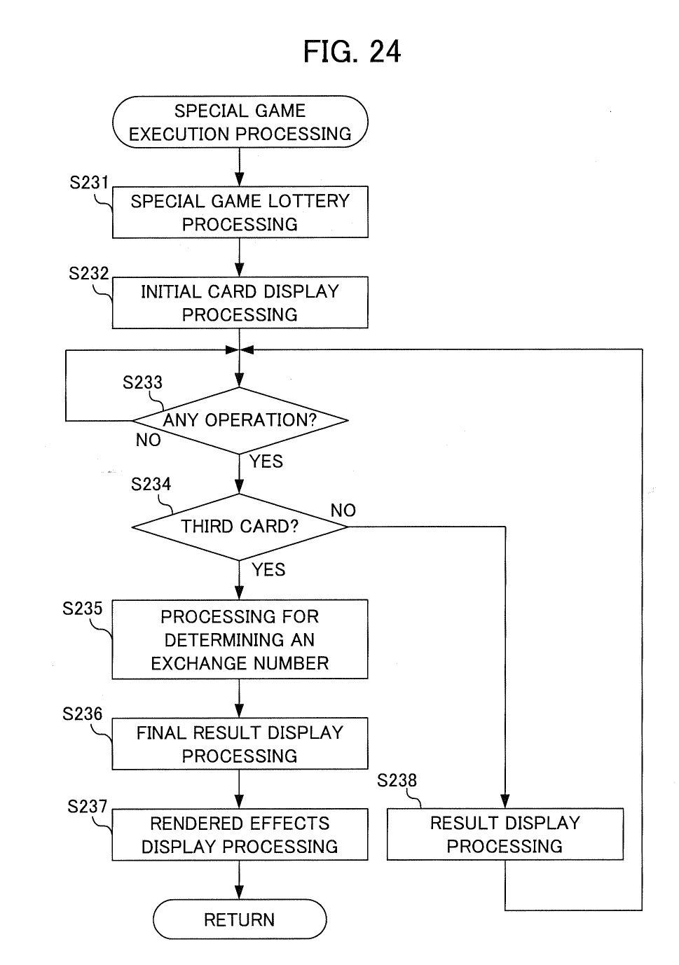

A second embodiment is described with reference to FIGS. 23 and 24. For the purpose of clarification, the following are only differences from the first embodiment. A poker gaming machine according to the second embodiment has basically the same overall view as the first embodiment. The second embodiment differs from the first embodiment in the bet processing and the processing for executing a special game.

a. Bet Processing

In the poker gaming machine according to the second embodiment, a bet processing subroutine is called. Firstly, the CPU 66 performs processing to judge if medals have been inserted, or a bet switch has been activated (step S221).

In this processing, the CPU 66 judges if it has received one of the following detection signals: a signal indicating medals having been inserted into the medal slot 63 from the medal detecting sensor 31, a signal indicating the bet max switch 26 having been activated and the bet one switch 28 having been activated. If the CPU 66 determines reception of any one of the signals, the CPU 66 advances the process to step S222. If the CPU 66 determines no reception, the CPU 66 repeats step S221.

In step S222, the CPU 66 performs processing for adding a bet number. In this processing, the CPU 66 adds the number of credits based on the result in step S221. Specifically, the CPU 66 controls the RAM 70 to store the sum of the number of detections of medal insertion and the number of times the bet one switch 28 has been activated, as a bet number. It should be noted that the maximum bet number is “5”. When the bet max switch 26 is activated, the maximum value of “5” is stored in the RAM 70, irrespective of the number of detections of medal insertion and the number of times the one switch 28 has been activated. When the processing for adding a bet number is terminated, the CPU 66 advances the process to step S223.

In step S223, the CPU 66 performs processing to judge if the deal switch 24 has been activated. In this processing, the CPU 66 judges if it has received a detection signal indicating the deal switch 24 having been activated. If not, the CPU 66 repeats step S223. If so, the CPU 66 advances the process to step S224.

In step S224, the CPU 66 performs processing to judge if the game is in the high-probability mode, based on the value of the high-probability flag stored in the RAM 70. The CPU 66 judges the game is in the high-probability mode if the value of the high-probability flag is at least 1. If so, the CPU 66 advances the process to step S225. If not, the CPU 66 terminates the present subroutine.

In step S225, the CPU 66 performs processing for executing a special game. This processing is described later. When this processing is terminated, the CPU 66 terminates the present subroutine.

b. Processing for Executing a Special Game

The processing for executing a special game called in step S225 (FIG. 23) is described with reference to FIG. 24.

In step S231, the CPU 66 performs processing for executing a special game lottery. More specifically, the CPU 66 performs processing to sample random numbers and refer to special game lottery tables stored in the ROM 68 so as to determine a deck number, etc. to be supplied in the special game. When this processing is terminated, the CPU 66 advances the process to step S232.

In step S232, the CPU 66 performs processing for displaying an initial card. In this processing, the CPU 66 supplies an instruction indicating a display of the images of the back faces of a plurality of cards to the display and input controller 200 via the input/output bus 64 and the interface circuit group 72. The display and input controller 200 reads out the corresponding image data, and controls the data to be stored in the video RAM within the display and input controller 200. In this way, the second display 33 displays the back faces of cards initially distributed to the player in the special game. When this processing is terminated, the CPU 66 advances the process to step S233.

In step S233, the CPU 66 performs processing to judge if any operation has been initiated. In this processing, the CPU 66 judges if the player has initiated a certain operation, receiving a detection signal from the second display 33 in response to the player's touch operation on the screen of the second display 33. If so, the CPU 66 advances the process to step 234. If not, the CPU 66 advances the process to step 233. Even if the CPU 66 does not judge that any operation has been initiated, the CPU 66 advances the process to step S234 after an elapse of a predetermined time (for example, 10 seconds).

In step S234, the CPU 66 performs processing to judge if it is the third card. In this processing, if the CPU 66 judges it is the third card turned over (the player's touch operation on the second display 33), the CPU 66 advances the process to step S235. If not, the CPU 66 advances the process to step 238.

In step S235, the CPU 66 performs processing for determining an exchange number. In this processing, the CPU 66 determines an allowable number of card exchanges in accordance with the result of the processing for executing a special game lottery (step S231). Then, the CPU 66 controls the determined allowable card exchange number to be stored in the residual exchange number counter in the RAM 70. When this processing is terminated, the CPU 66 advances the process to step S236.

In step S236, the CPU 66 performs processing for displaying a final result. In this processing, the CPU 66 supplies an instruction indicating a display of the images of the final result (the face-up three cards) to the display and input controller 200 via the input/output bus 64 and the interface circuit group 72. The display and input controller 200 reads out the corresponding image data, and controls the data to be stored in the video RAM within the display and input controller 200. In this way, the second display 33 displays the final result. When this processing is terminated, the CPU 66 advances the process to step S237.

In step S237, the CPU 66 performs processing for displaying rendered effects. In this processing, the CPU 66 transmits an instruction indicating a display of an image of rendered effects (for example, an erupting volcano image, etc.) to the display and input controller 200 via the input/output bus 64 and the interface circuit group 72. The display and input controller 200 reads out the corresponding image data, and controls the data to be stored in the video RAM within the display and input controller 200. In this way, the second display 33 displays the image of rendered effects. When this processing is terminated, the CPU 66 terminates the present subroutine.

In step S236, the CPU 66 performs processing for displaying a result. In this processing, the CPU 66 transmits an instruction indicting a display of an image related to a result (for example, the face-up cards, etc.) to the display and input controller 200 via the input/output bus 64 and the interface circuit group 72. The display and input controller 200 reads out the corresponding image data, and controls the data to be stored in the video RAM within the display and input controller 200. In this way, the second display 33 displays the image of a result. When this processing is terminated, the CPU 66 advances the process to step S233. Thus, the CPU 66 is an example of a controller which executes the special game for each of the high-probability win games.

While the embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. A gaming machine comprising:
a display; and
a controller that controls the display so as to display an image related to a high-probability win game,
wherein the controller is configured with logic to:
(a) distribute cards to a player;
(b) exchange one or more of the distributed cards selected by the player with different cards;
(c) execute a win game in which the player wins a predetermined award when the final cards possessed by the player includes a first predetermined card combination;
(d) execute a plurality of high-probability win games in a subsequent game when the final cards include a second predetermined card combination; and
(e) execute a special game so as to determine an allowable number of times to exchange cards prior to executing a high-probability win game.

2. The gaming machine according to claim 1,
wherein the allowable number of times to exchange cards is a total number allowed for the plurality of high-probability win games continuously performed, and
the controller is further configured with logic to: (f) control the allowable number of times to exchange cards to be consumed in the plurality of high-probability win games.

3. The gaming machine according to claim 1, wherein the controller performs a special game for each high-probability win game.

4. A gaming machine comprising:
a display; and
a controller that controls the display so as to display an image related to a high-probability win game,
wherein the controller is configured with logic to:
(a) distribute cards to a player;
(b) exchange one or more of the distributed cards selected by the player with different cards;
(c) execute a win game in which the player wins a predetermined award when the final cards possessed by the player includes a first predetermined card combination;
(d) execute a plurality of high-probability win games in a subsequent game when the final cards include a second predetermined card combination;
(e) execute a special game so as to determine an allowable total number of times to exchange cards for the plurality of high-probability win games prior to executing a high-probability win game; and
(f) control the allowable number of times to exchange cards to be consumed in the plurality of high-probability win games.

5. A gaming machine comprising:
a display; and
a controller that controls the display so as to display an image related to a high-probability win game,
wherein the controller is configured with logic to:
(a) distribute cards to a player;
(b) exchange one or more of the distributed cards selected by the player with different cards;
(c) execute a win game in which the player wins a predetermined award when the final cards possessed by the player includes a first predetermined card combination;
(d) execute a plurality of high-probability win games in a subsequent game when the final cards include a second predetermined card combination; and
(e) execute a special game so as to determine an allowable number of times to exchange cards prior to executing a high-probability win game, wherein the controller is configured with logic to execute a special game for each high-probability win game.

6. A method of controlling a gaming machine with a display, the method comprising the steps of:
(a) distributing cards to a player;
(b) exchanging one or more of the distributed cards selected by the player with different cards;
(c) executing a win game in which the player wins a predetermined award when the final cards possessed by the player includes a first predetermined card combination;
(d) executing a plurality of high-probability win games in a subsequent game when the final cards include a second predetermined card combination;
(e) executing a special game so as to determine an allowable number of times to exchange cards prior to executing a high-probability win game; and
(f) controlling the display so as to display an image related to the high-probability win game.

7. The method according to claim 6,
wherein the allowable number of times to exchange cards is a total number allowed for the plurality of high-probability win games continuously performed, and
the method further includes the step of:
(g) controlling the allowable number of times to exchange cards to be consumed in the plurality of high-probability win games.

8. The method according to claim 6, wherein the controller performs a special game for each high-probability win game.

9. A method of playing a win game, the method comprising the steps of:
(a) distributing cards to a player;
(b) exchanging one or more of the distributed cards selected by the player with different cards;
(c) executing a win game in which the player wins a predetermined award when the final cards possessed by the player include a first predetermined card combination;
(d) executing a plurality of high-probability win games in a subsequent game when the final cards include a second predetermined card combination; and
(e) executing a special game so as to determine an allowable number of times to exchange cards prior to executing a high-probability win game.
